(19) United States
(12) Patent Application Publication
(10) Pub. No.: US 2015/0250681 A1
(43) Pub. Date: Sep. 10, 2015

(54) VIAL ADAPTER FOR USE WITH SYRINGE HAVING WIDENED DISTAL SYRINGE TIP

(71) Applicant: MEDIMOP Medical Projects Ltd., Ra'anana (IL)

(72) Inventors: Nimrod Lev, Savion (IL); Moshe Gilboa, Kfar Saba (IL)

(21) Appl. No.: 14/366,306

(22) PCT Filed: Dec. 9, 2012
(86) PCT No.: PCT/IL2012/050516

§ 371 Date: Jun. 18, 2014

(30) Foreign Application Priority Data
Dec. 19, 2011 (IL) 217091

(51) Int. Cl. A61J 1/20

(52) U.S. Cl. CPC A61J 1/2096; A61J 1/201; A61J 1/2048

(57) ABSTRACT

A vial adapter for use with a syringe having a widened distal syringe tip, and a medicinal vial. The vial adapter includes a top wall, a skirt for telescopically slidingly receiving the medicinal vial, a downwardly depending puncturing spike, and a syringe port opposite the puncturing spike and in flow communication therewith. The syringe port is formed with at least two upright syringe port members for being initially outwardly flexed on the sliding insertion of the widened distal syringe tip into the syringe port and subsequently snapping behind the widened distal syringe tip on its forced full sliding insertion into the syringe port to retain the widened distal syringe tip in said syringe port.

### FIELD OF THE INVENTION

The invention pertains to liquid drug delivery devices for use with syringes having widened distal syringe tips for preventing a conventional needle with a female Luer connector being slidingly mounted thereon.

### BACKGROUND OF THE INVENTION

Commonly owned PCT International Application No. PCT/IL2005/000376 entitled Liquid Drug Delivery Devices and Needle Shield Removal Device and published under PCT International Publication No. WO 2005/105014 discloses in FIGS. 8 to 11 a liquid drug transfer device including a vial adapter with elastomer tubing for preparing a syringe having a widened distal syringe tip with a reconstituted liquid drug for immediate administration to a subject. The widened distal syringe tip is dimensioned to prevent a conventional needle being slidingly mounted thereon. The elastomer tubing's free end is intended to be sealingly stretched over a syringe's widened distal syringe tip for effecting fluid communication between a syringe and a medical vial containing a medicament requiring reconstitution. Reconstitution typically requires agitation of the assemblage of the liquid drug transfer device, a vial and a syringe which may lead to inadvertent syringe detachment and contents spillage.

Commonly owned PCT International Application No. PCT/IL2008/001278 entitled Liquid Drug Delivery Device For Use With Syringes With Widened Distal Syringe Tips and published under PCT International Publication No. WO 2009/040804 discloses liquid drug delivery devices including a housing with a syringe port for sealingly receiving a syringe having a syringe tip ending at a widened distal syringe tip, a vial adapter port with a vial adapter for snap fit receiving a vial, and a drug administration port for administering a liquid drug. The vial adapter is intended to be rotationally detached after a mixing procedure for discarding together with a spent vial. The syringe port additionally includes a single use locking mechanism for securing the syringe to preclude inadvertent syringe detachment under normal use including agitation for reconstitution purposes. The drug administration port has a distal syringe tip preferably similar to a syringe's widened distal syringe tip for the same purpose of preventing conventional needles with a female Luer connector being slidingly mounted thereon.

### SUMMARY OF THE INVENTION

The present invention is directed toward vial adapters for safely and securely preparing a syringe having a widened distal syringe tip with a liquid drug for immediate administration to a subject. The vial adapters include a skirt for snap fitting onto a drug vial, a puncturing spike for puncturing a drug vial stopper and a syringe port in fluid communication with the puncturing spike and designed to snap fit onto a widened distal syringe tip. The syringe port preferably includes two or more upright syringe port members designed to initially outwardly flex on initial sliding insertion of the widened distal syringe tip thereinto and subsequently snap behind the widened distal syringe tip on its forced full sliding insertion thereinto to retain the widened distal syringe tip in the syringe port. The syringe port is also designed to enable convenient detachment of a filled syringe from an assemblage of a vial adapter and its emptied vial by manual application of a detachment force to momentarily outwardly flex one or more of its syringe port members. The syringe port is also designed such that inadvertent insertion of a syringe with a conventional Luer tip will neither form a sealed flow communication therewith nor mechanically engage the syringe port. The vial adapter of the present invention enables secure reconstitution of a drug medicament without concern of inadvertent detachment. The vial adapter is designed for convenient low cost manufacturing. The vial adapters of the present invention can be implemented in vented or non-vented versions.

### BRIEF DESCRIPTION OF THE DRAWINGS

In order to understand the invention and to see how it can be carried out in practice, a preferred embodiment will now be described, by way of a non-limiting example only, with reference to the accompanying drawings, in which similar parts are likewise numbered, and in which:

FIG. 1A corresponds to aforesaid commonly owned WO 2005/105014's FIG. 8 showing a liquid drug transfer device including a vial adapter with elastomer tubing for preparing a syringe having a widened distal syringe tip with a reconstituted liquid drug for immediate administration to a subject;

FIG. 1B corresponds to aforesaid commonly owned WO 2005/105014's FIG. 9 showing a longitudinal cross section of the liquid drug transfer device along line A-A in FIG. 1A;

FIG. 2A corresponds to aforesaid commonly owned WO 2009/040804's FIG. 6 showing a liquid drug delivery device including a syringe port with elastomer tubing and an automatic single use locking mechanism for use with a syringe having a widened distal syringe tip for safely and securely preparing the syringe with a reconstituted liquid drug;

FIG. 2B corresponds to aforesaid commonly owned WO 2009/040804's FIG. 8 showing an assembled side view of the liquid drug delivery device and a syringe with a widened distal syringe tip;

FIG. 3 is a top perspective view of a vial adapter with a syringe port for use with a syringe with a widened distal syringe tip in accordance with the present invention;

FIG. 4 is a longitudinal cross section of FIG. 3's vial adapter along line B-B in FIG. 3;

FIG. 5 is longitudinal cross section of FIG. 3's vial adapter along line B-B in FIG. 3 subsequent to partial insertion of the widened distal syringe tip into the syringe port;

FIG. 6 is longitudinal cross section of FIG. 3's vial adapter along line B-B in FIG. 3 subsequent to full snap fit insertion of the widened distal syringe tip into the syringe port; and

FIGS. 7A to 7D show the use of the vial adapter of the present invention for preparing a syringe with a reconstituted liquid drug ready for administration.

### DETAILED DESCRIPTION OF THE DRAWINGS

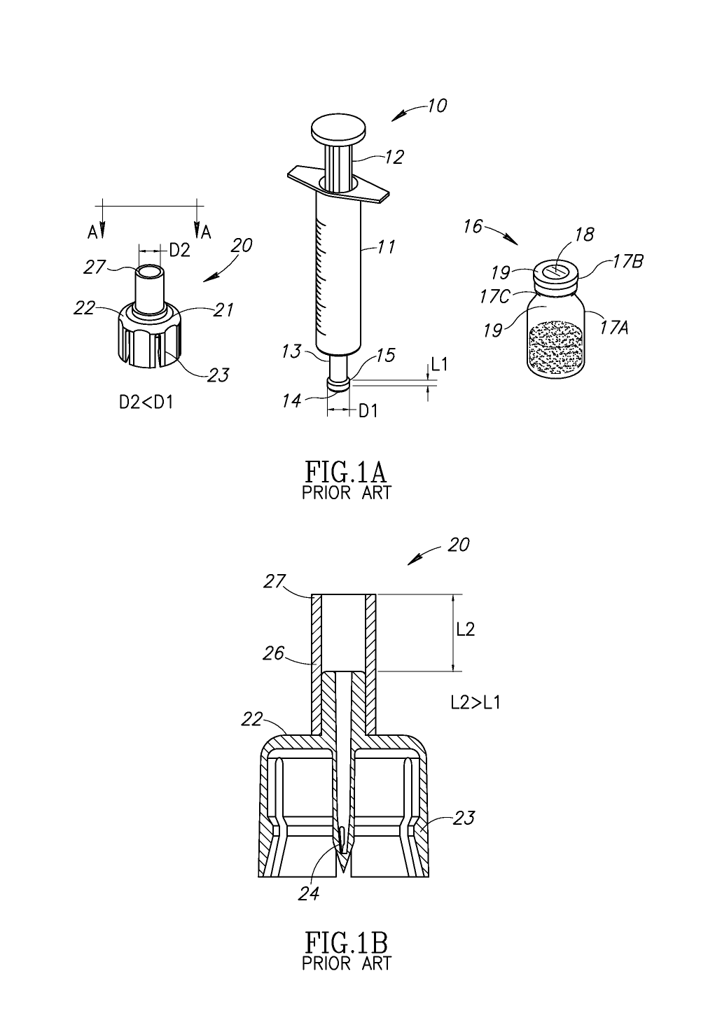

FIG. 1A shows a syringe 10, a vial 16 and a liquid drug transfer device 20 for liquid drug reconstitution purposes. The syringe 10 includes a barrel 11 with a plunger 12 and a syringe tip 13 ending at a widened distal syringe tip 14 for preventing the sliding mounting of a conventional needle with a female Luer connector thereon. The syringe tip 14 has an outer diameter D1, a length L1 and an annular trailing surface 15. The syringe 10 includes liquid contents for forming a liquid drug in the vial 16. The liquid contents can be constituted by a diluent for reconstituting a powder drug or mixing with a liquid drug. Alternatively, the liquid contents can include an active drug component. The vial 16 includes an open topped bottle 17A, a vial opening 17B stopped by a drug vial stopper 18, and a narrow neck 17C intermediate the bottle 17A and the vial opening 17B. The bottle 17A has a vial interior 19 including a powder or liquid drug 19.

FIGS. 1A and 1B show the liquid drug transfer device 20 includes a vial adapter 21 with a top wall 22, a resiliently deformable slitted skirt 23 for snap fitting onto the vial 16, and a hollow puncturing spike 24 for puncturing the vial stopper 18, and an elastomer tubing 26 in flow communication with the puncturing spike 24. The tubing 26 has a distal end 27 for sealingly fitting over the syringe tip 14 for enabling flow communication between the syringe 10 and the vial 16. The tubing 26 has an internal diameter D2 where D2<D1 and a free length L2 from its attachment point with the vial adapter 21 where L2>L1 for being sealingly stretched over preferably the entire syringe tip 14 without tearing, ripping, and the like. The tubing 26 is preferably formed from one of the following substances: PVC, silicone, rubber, and the like.

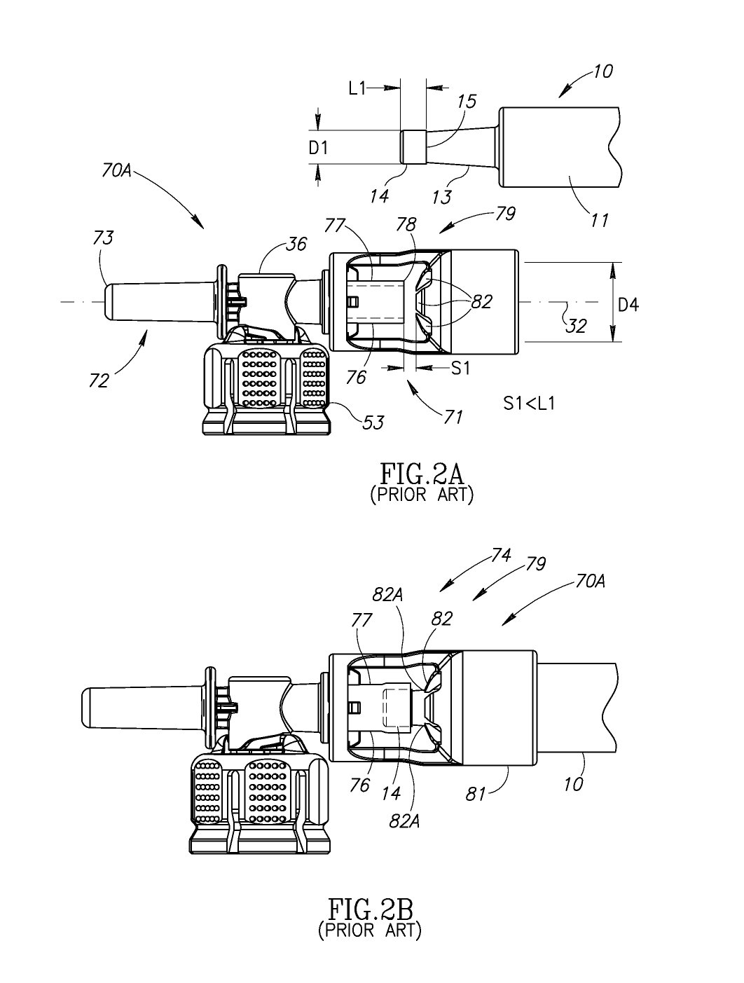

FIGS. 2A and 2B show a liquid drug delivery device 70A for use with a syringe 10 and a vial 16. The liquid drug delivery device 70A is similar in construction and operation to the fluid control device illustrated and described in U.S. Pat. No. 6,238,372 to Zinger et al. The fluid control device 70A includes a syringe port 71 designed to effect sealed fluid communication with a syringe 10 and a drug administration port 72 having a widened distal syringe tip 73 for preventing conventional needles with a female Luer connector being slidingly mounted thereon in a similar manner as the syringe 10.

The syringe port 71 includes an inlet port 74 provisioned with an elastomeric tubular sealing member 76 constituted by elastomer tubing 77 having a free end 78 and co-axial with a longitudinal axis 32. The tubing 77 is preferably formed from PVC, silicon, rubber, and the like, for sealingly receiving the syringe tip 14 on forced sliding insertion thereinto. The inlet port 74 supports an automatic single use locking mechanism 79 for precluding inadvertent syringe detachment. The locking mechanism 79 includes a solid tubular guide member 81 co-axial with the longitudinal axis 32 for assisting in user alignment of the syringe 10 along the longitudinal axis 32 for insertion into the syringe port 71 but with an inner diameter D4 slightly larger than D1 such that the syringe tip 14 can freely pass therethrough. The guide member 81 has four equispaced resiliently flexible stopping members 82 inwardly converging towards a vial adapter port 36 and terminating at stopping member tips 82A which stop short of the free end 78 by a separation S1 and define an aperture having a smaller diameter than the diameter D1 such that the syringe tip 14 resiliently radially outwardly urges the stopping members 82 which snap behind same to encircle the syringe tip 14 on forced sliding insertion therethrough. Inadvertent detachment of the syringe 10 from the liquid drug delivery device 70A is prevented by the trailing surface 15 stopping against the stopping member tips 82A. The separation S1 is smaller than the length L1 for ensuring the syringe tip 14 remains within the tubing 77 when the trailing surface 15 abuts against the stopping member tips 82A in the most rearward position of the syringe 10 with respect to the device 70A.

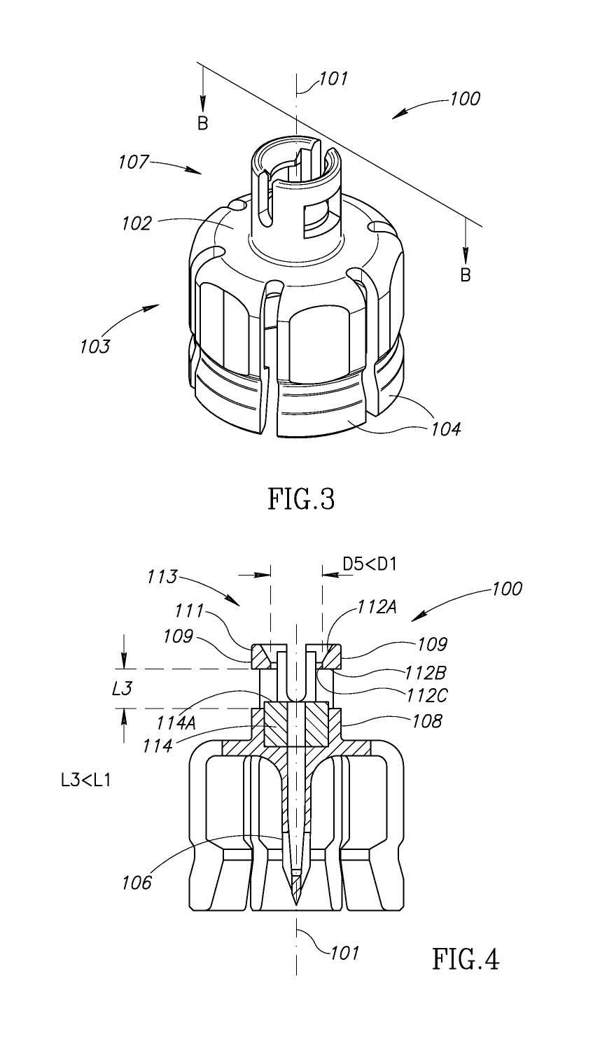

FIGS. 3 to 6 show a vial adapter 100 having a longitudinal vial axis 101 and including a transverse top wall 102 having a downward depending skirt 103 with flex members 104 for snap fitting onto a vial 16. The vial adapter 100 includes a downward depending hollow puncturing spike 106 for puncturing the drug vial stopper 18 on snap fitting the skirt 103 on the vial 16 for flow communication with the vial interior 19, and a central axial directed syringe port 107 oppositely directed to the puncturing spike 106 and in flow communication therewith.

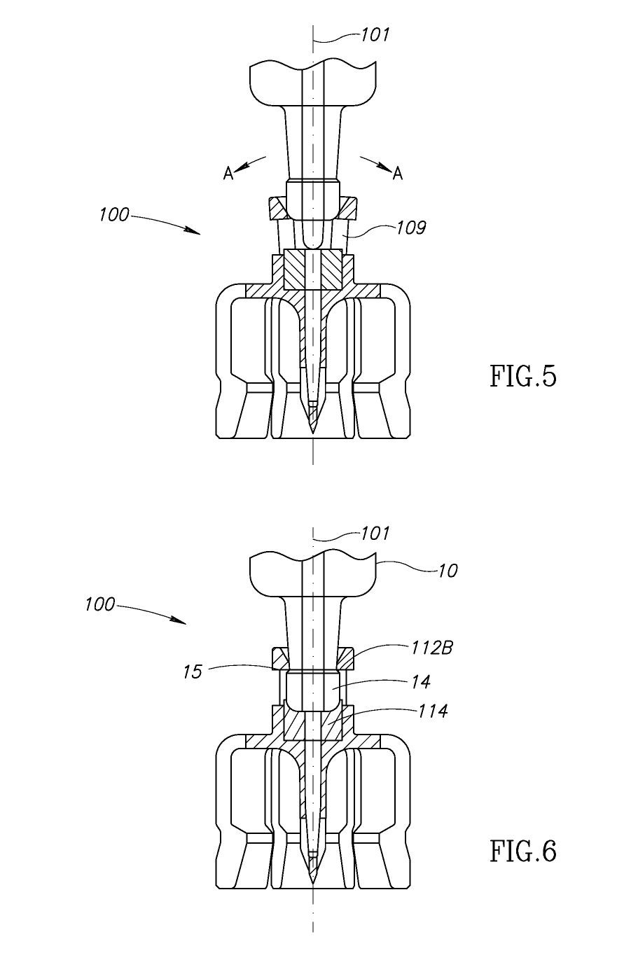

The syringe port 107 includes an annular base 108 and a pair of upright opposite syringe port members 109 resiliently flexibly mounted thereon. The syringe port members 109 each have inwardly directed syringe port member rim 111. The syringe port member rims 111 each have an uppermost inclined surface 112A facing away from the base 108 and converging theretowards, an underside syringe port member rim surface 112B facing towards the base 108, and an intermediate axial directed syringe port member rim surface 112C between its adjacent uppermost inclined surface 112A and the underside syringe port member rim surface 112B. The syringe port member rim surfaces 112C define an opening 113 with a diameter D5 where D5<D1 such that initial sliding insertion of a syringe tip 14 into the syringe port 107 outwardly flexes the syringe port members 109 relative to the longitudinal vial axis 101 as denoted by arrows A in FIG. 5.

The syringe port members 109 snap behind the widened distal syringe tip 14 on its forced full insertion into the syringe port 107 such that their underside syringe port member rim surfaces 112B stop against the syringe tip's annular trailing surface 15 to retain the widened distal syringe tip 14 in the syringe port 107 (see FIG. 6). The syringe port members 109 preferably revert to their unflexed position. Application of a detachment force at a skewed angle relative to the longitudinal vial axis 101 momentarily outwardly flexes one or more syringe port members 109 sufficiently to enable withdrawal of the syringe tip 14 from the syringe port 107 for convenient release of a syringe 10 filled with a reconstituted liquid drug ready for administration.

The annular base 108 is fitted with an O-ring like sealing member 114 formed from suitable bio-compatible materials, for example, rubber, silicon, and the like. The sealing member 114 has an uppermost surface 114A facing towards the underside syringe port member rim surfaces 112B. The sealing member's uppermost surface 114A and the underside syringe port member rim surfaces 112B define a length L3 where L3<L1 such that the syringe tip 14 compresses the sealing member 114 on full sliding insertion of the syringe tip 14 into the syringe port 107 (see FIG. 6).

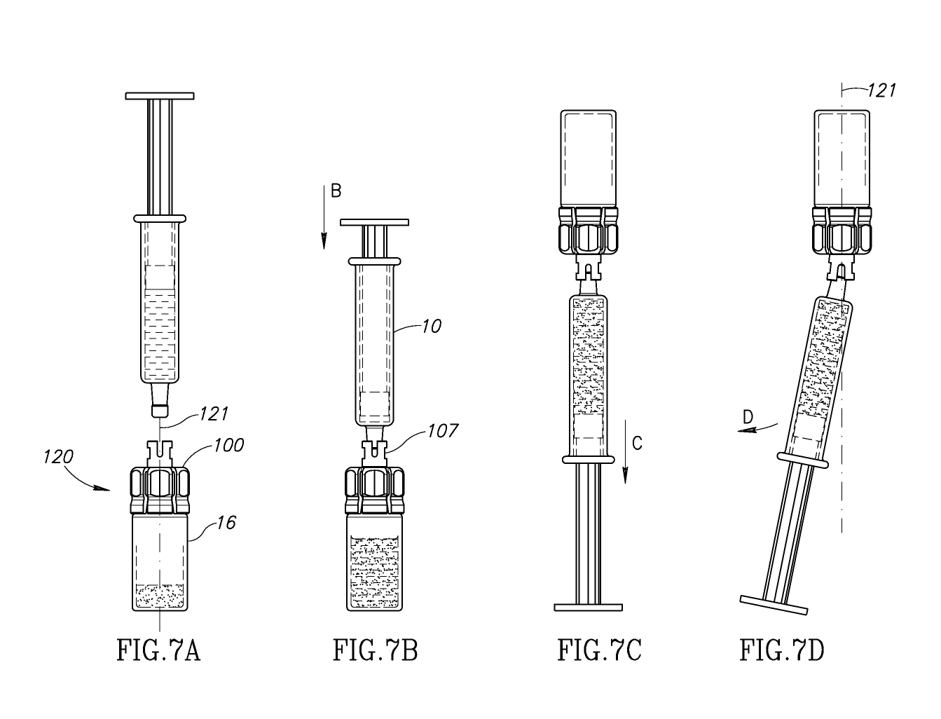

FIGS. 7A to 7D show the use of the vial adapter 100 as follows:

FIG. 7A shows an assemblage 120 of a vial adapter 100 and a vial 16 after snap fitting mounting the former onto the latter. The assemblage 120 has a longitudinal assemblage axis 121 co-axial with the longitudinal axes of the vial adapter and the vial. FIG. 7B shows the assemblage subsequent to full snap fit insertion of the syringe 10 into the syringe port 107 to ensure a sealed flow connection and injection of the syringe's liquid contents into the vial for reconstitution purposes as denoted by arrow B. FIG. 7C shows the assemblage and the syringe subsequent to inversion for aspiration of the reconstituted liquid drug into the syringe 10 for aspiration purposes as denoted by arrow C. FIG. 7D shows application of a detachment force D skewed relative to the longitudinal assemblage axis 121 to enable detachment of the syringe from the vial adapter 100 and its empty attached vial 16.

While the invention has been described with respect to a limited number of embodiments, it will be appreciated that many variations, modifications, and other applications of the invention can be made within the scope of the appended claims.

1-2. (canceled)

1-2. (canceled)

3. A vial adapter for use with a syringe having a widened distal syringe tip, and a medicinal vial including an open topped bottle having a vial interior containing a medicament, a vial opening stopped by a vial stopper, and a narrow neck intermediate the bottle and the vial opening, the vial adapter having a longitudinal vial axis and comprising
a top wall transverse to the longitudinal vial axis,
a substantially cylindrical skirt having flex members resiliently attached to said top wall and downwardly depending therefrom for telescopically slidingly receiving the vial opening therein,
a downwardly depending puncturing spike for puncturing the vial stopper for establishing flow communication with the vial interior,
a syringe port opposite to said puncturing spike and in flow communication with the vial interior on said puncturing spike puncturing the vial stopper,
said syringe port being formed with at least two upright syringe port members for being initially, outwardly flexed relative to the longitudinal vial axis on initial sliding insertion of the widened distal syringe tip into said syringe port and subsequently snapping behind the widened distal syringe tip on its forced full sliding insertion into said syringe port to retain the widened distal syringe tip in said syringe port and said syringe port being formed such that, on application of a detachment force at a skewed angle relative to said longitudinal vial axis, at least one of said at least two syringe port members is outwardly flexed for enabling withdrawal of the syringe tip from said syringe port.

4. The adapter according to claim 3 wherein said syringe port includes an O-ring like sealing member undergoing compression on said full snap fit insertion of the widened distal syringe tip into said syringe port for ensuring sealed flow communication between the widened distal syringe tip and said puncturing spike.
